(19) United States
(12) Patent Application Publication
(10) Pub. No.: US 2001/0006549 A1
(43) Pub. Date: Jul. 5, 2001

(54) Telephone subscriber call signal control device and subscriber circuit terminating device

(75) Inventors: Kazuhiko Harasaki, Tokyo (JP); Nobuyuki Kitada, Iwate (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/748,378

(22) Filed: Dec. 27, 2000

(30) Foreign Application Priority Data
Dec. 27, 1999 (JP) 11-371060

(51) Int. Cl. H04M 1/00; H04M 3/00

(52) U.S. Cl. 379/373.03

(57) ABSTRACT

Disclosed is a telephone subscriber call signal control device for calling a telephone set connected to a subscriber circuit by means of a ringing signal when an incoming call is outputted from a subscriber circuit terminating device.

The subscriber circuit terminating device comprises:

a zero crossing point detection circuit for generating a zero crossing point synchronization signal synchronous with a zero potential of said ringing signal, and an order output timing adjustment circuit for adjusting output timing of a ringing control order for controlling a ringing relay of the subscriber circuit synchronously with the zero crossing point synchronization signal, and the telephone set is called by the ringing signal through the subscriber circuit synchronously with the zero crossing point synchronization signal in accordance with reception of an order to output a command to turn on the ringing relay from an order output device connected to the subscriber terminating device.

### FIELD OF THE INVENTION

The present invention relates to a telephone subscriber call signal control device for ringing a ringing signal when an incoming call reaches a telephone set and a subscriber circuit terminating device including the telephone subscriber call signal control device.

### BACKGROUND OF THE INVENTION

Conventionally, if each telephone set is called by an incoming call tone from a subscriber circuit terminating device, a DC voltage ringing signal is supplied to the telephone set and a ringing tone is generated to thereby urge a telephone subscriber to hang up the receiver. A sinusoidal current signal of 16 Hz and 79 Vrms with respect to a DC voltage of -48 V is employed as the ringing signal for ringing the subscriber's telephone set with a call tone, which example is shown in FIG. 1 and will be described with reference to FIG. 1.

In FIG. 1, an exchange or a repeater station connected by many telephone sets consists of an order transmission device 400 transmitting an order to output a ringing to, for example, a predetermined telephone number, a subscriber circuit terminating device 100 connected to the order output device 400 and having an order development circuit switching connection in accordance with an incoming call order, subscriber circuits #0, . . . #N usually provided in the exchange for respective subscribers, connected to the subscriber circuit terminating device and having relay control circuit 210 and switch relays RL1 and RL2, a subscriber's telephone set 600 usually provided in the exchange and connected to each of the subscriber circuits #0, . . . #N by a ring line and a chip line, and a ringing signal transmission device 500 generating a ringing signal for notifying the telephone set 600 of an incoming call and provided in the exchange. Switching for connecting to the desired telephone set which is a main function of the exchange is conducted outside of the subscriber circuit terminating device 100 and it is connected to the order development circuit 120 as a voice signal.

As shown in FIG. 1, at the time of outputting a call signal, the telephone exchange has an overvoltage suppression circuit (spark killer) for each subscriber circuit so as to suppress overvoltage generated on subscriber lines, ring lines and chip lines. The overvoltage suppression circuit constitutes a spark killer circuit out of a serial circuit consisting of a resistor R11 and a capacitor C11 connected to the both ends of each of the switch relays RL1 and RL2 within the subscriber circuits #0 and #N. The switch relays RL1 and RL2 select a ringing signal for one second and the output of a relay control circuit 210 for two seconds, whereby a call tone is generated from the telephone set 600.

In this case, if the switch relays can be successfully switched with the ringing signal having a voltage close to 0V, excessive voltage change does not occur and no problem arises even without the spark killer. If the ringing signal is high and the switch relays RL1 and RL2 are switched, the ringing signal is sometimes superimposed in addition to voltage supplied from the relay control circuit. Due to this, abnormally high voltage may be applied between the two-wire lines of the telephone set 600, and a CR circuit serving as the spark killer of the overvoltage suppression circuit which suppresses the generation of the high voltage suppresses the application of the high voltage between the two-wire lines.

Nevertheless, with the constitution of this conventional case, the spark killer circuit having the same constitution as that of the overvoltage suppression circuit is provided to the subscriber circuit for supplying a ringing signal to each telephone set for every subscriber. Due to this, the exchange of the subscriber circuit storage device accommodating many subscribers disadvantageously pushes up system cost.

### BRIEF SUMMARY OF THE INVENTION

It is, therefore, an object of the present invention to decrease the number of overvoltage suppression circuits of subscriber circuits supplying a ringing signal to telephone sets and to suppress high voltage when the telephone sets are called by means of a subscriber circuit terminating device.

The present invention is directed to decrease whole system cost between an exchange and subscriber circuits by, when outputting a call signal, synchronizing a method of suppressing overvoltage generated on a subscriber line with a zero crossing point signal indicating a potential VB (V) of a call signal whereby providing a host apparatus of a subscriber circuit terminating the subscriber circuit with a structure of operating a ringing relay as an integrated circuit.

The present invention is a telephone subscriber call signal control device for calling a telephone set connected to a subscriber circuit by means of a ringing signal when an incoming call is outputted from a subscriber circuit terminating device, characterized in that: the subscriber circuit terminating device comprises: a zero crossing point detection circuit generating a zero crossing point synchronization signal synchronous with a zero potential of the ringing signal, and an order output timing adjustment circuit adjusting output timing of a ringing control order for controlling a ringing relay of the subscriber circuit synchronously with the zero crossing point synchronization signal, and the telephone set is called by the ringing signal through the subscriber circuit synchronously with the zero crossing point synchronization signal in accordance with reception of an order to output a command to turn on the ringing relay from an order output device connected to the subscriber terminating device.

Further, the present invention is a subscriber circuit terminating device, including a ringing signal transmission device, for supplying a ringing signal to a subscriber circuit, characterized by comprising: a zero crossing point detection circuit generating a zero crossing point synchronization signal synchronous with a zero potential of the ringing signal; an order output timing adjustment circuit adjusting output timing of a ringing control order controlling a ringing relay of the subscriber circuit synchronously with the zero crossing point synchronization signal; and an order development circuit inputting an order reception signal from an order output device and analyzing the order reception signal, and characterized in that a telephone set is called by the ringing signal synchronized with the zero crossing point synchronization signal by the order output timing adjustment circuit in accordance with the order reception signal from the order output device.

Furthermore, the present invention is characterized in that a control mechanism for controlling a call signal (or a ringing signal) in a subscriber circuit at the zero crossing point of the call signal to prevent the generation of overvoltage on a subscriber line when controlling the call signal is provided in a host apparatus.

Moreover, the present invention will be described with reference to FIG. 2. A call signal transmitted from a ringing signal transmission device 500 is inputted into a zero crossing point detection circuit 130. The zero crossing detection circuit 130 detects the potential zero crossing point of the call signal and generates a synchronization signal synchronous with the zero crossing point. This zero crossing synchronization signal is inputted into an order output timing adjustment circuit 110. The order output timing adjustment circuit 110 synchronizes a ringing order transmitted from an order output device and controlling the ringing relays RL1 and RL2 of a subscriber circuit #0, with the above-stated zero crossing synchronization signal, and outputs the ringing order to a subscriber circuit. In response to the ringing order outputted at this timing, the subscriber circuit #0 or the like operates the ringing relays. This operation can prevent the generation of overvoltage on subscriber lines during relay operation.

### BRIEF DESCRIPTION OF THE DRAWINGS

FIG. 1 is a block diagram of an order output timing circuit of a conventional subscriber circuit terminating device.

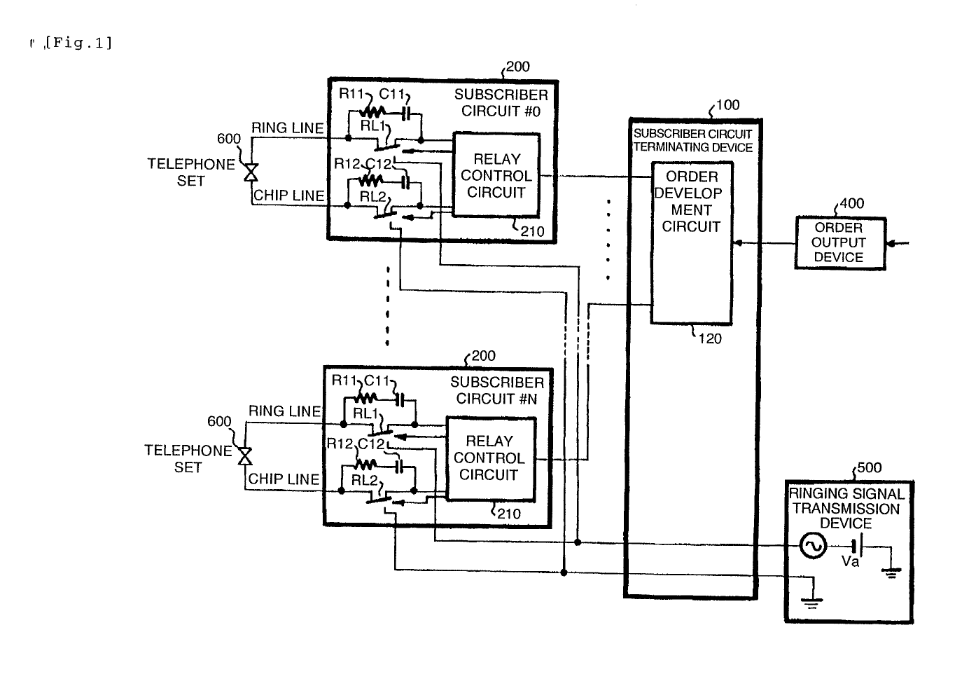

FIG. 2 is a block diagram of a subscriber circuit terminating device and peripheral devices of the subscriber circuit terminating device according to the present invention;

FIG. 3 is a block diagram of an order output timing circuit of the subscriber circuit terminating device according to the present invention;

FIG. 4 is a block diagram of a zero crossing point detection circuit of the subscriber circuit terminating device according to the present invention;

FIG. 5 is a timing chart showing an example of the operation of the subscriber circuit terminating device according to the present invention;

FIG. 6 is a block diagram of an order output timing circuit of the subscriber circuit terminating device according to the present invention; and

### DESCRIPTION OF THE PREFERRED EMBODIMENTS

The embodiments of the present invention will be described hereinafter in detail with reference to the accompanying drawings.

[First Embodiment]

(1) Description of Constitution

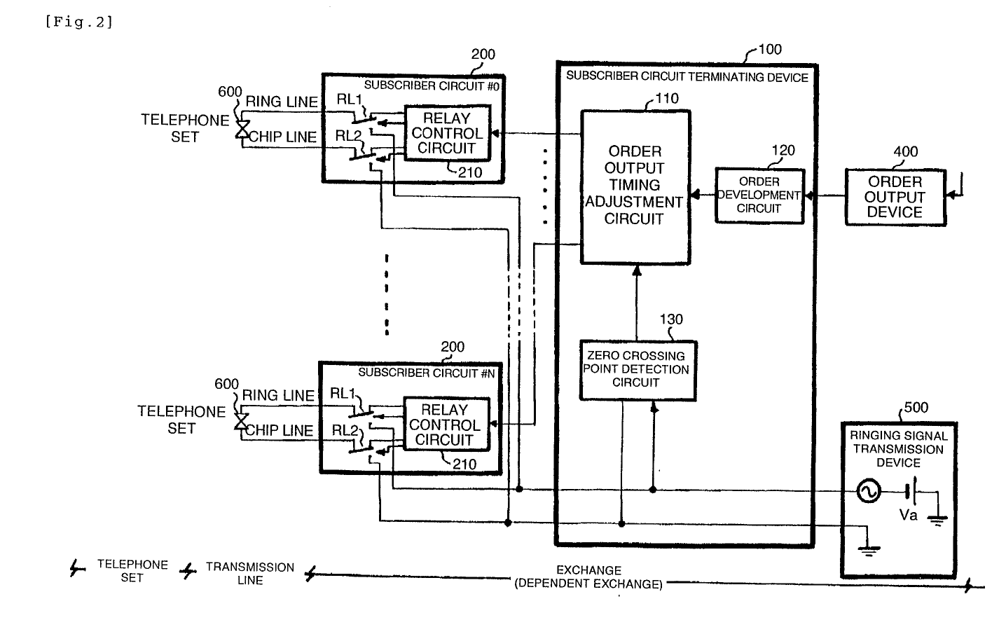

As shown in FIG. 2, a telephone line signal supplied by way of a repeater station or the like reaches an exchange which is a final dependent exchange. The exchange consists of a subscriber circuit terminating device 100 for notifying, in particular, a subscriber of an incoming call, an order output device 400 for issuing an order to notify an incoming call, a ringing signal transmission device 500 outputting a ringing signal and a plurality of subscriber circuits 200.

Referring further to FIG. 2, the subscriber circuit terminating device 100 has an order output timing adjustment circuit 110, an order development circuit 120 and a zero crossing point detection circuit 130.

In the order output timing adjustment circuit 110, a command signal, which is a control order or an order signal, outputted from the order output device 400 to the plural subscriber circuits 200 connected is developed by an order development circuit 120 for analyzing and developing the order signal for every subscriber. A ringing control order signal is extracted from the order signal thus developed and outputted by an order development circuit 120. The extracted ringing control order signal is synchronized with a ringing signal zero crossing synchronization signal outputted from the zero crossing point detection circuit 130 and outputted to a specific subscriber circuit 200 ordered by the order output device 400. It is the feature of this embodiment that the zero crossing point detection circuit 130 and the order output timing adjustment circuit are provided in the subscriber circuit terminating device 100.

The zero crossing point detection circuit 130 receives a call signal (or a ringing signal) transmitted from the ringing signal generation device 500 and generates a zero crossing synchronization signal indicating the potential VB (V) of the ringing signal. The zero crossing synchronization signal thus generated is outputted to the order output timing adjustment circuit 110 described above. The subscriber circuit #0 (200) controls the operation of the relay control circuit 210 to the switch relay RL1 or RL2 so as to repeat transmitting a ringing signal from the ringing signal transmission device 300 for, for example, one second and turning on/off the switch relay RL1 or RL2 with two second's null in accordance with a ringing relay control order signal outputted from the order output timing adjustment circuit 110. As a result of this operation, a call tone bell according to the ringing signal of the subscriber telephone set 600 rings.

Further, the order output device 400 outputs a command or the like for ordering the output of a ringing voice as the target of this embodiment together with other commands including, for example, a voice level adjustment command used in the subscriber circuit and a balancing network adjustment command from a switching exchange, a line monitoring device or the like which is not shown in FIG. 2.

It is the order development circuit 120 that distributes various commands from the order output device 400. The order development circuit 120 outputs the command to output the ringing signal to the relay control circuit 210, to the order output timing adjustment circuit 110. Further, the subscriber circuit 200 on/off controls the relays RL1 and RL2 using a control signal which timing is adjusted by the order output timing adjustment circuit 110. Thus, it is possible to prevent high voltage application. At this moment, the control signal of the relay control circuit 210 sets a ringing signal for, for example, one second and null time for, for example, two seconds, and a voltage of -48V on a ringing line side, a voltage of 0V on a chip line side and the ringing signal are supplied from the relay control circuit so as to switch them.

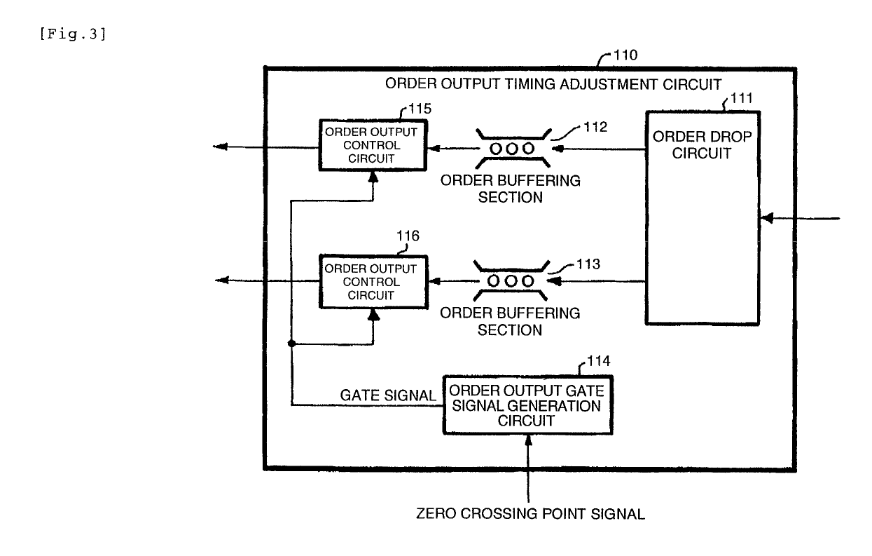

FIG. 3 shows a case where the order output timing adjustment circuit 110 is provided while there are two subscribers in the embodiment according to the present invention and is a block diagram showing an example of the constitution of the order output timing adjustment circuit 110.

The order output timing adjustment circuit 110 consists of an order drop circuit 111, an order buffering sections 112 and 113, order output control circuits 115 and 116 and an order output gate signal generation circuit 114. The order drop circuit 111 drops only a ringing relay control order signal in a subscriber circuit control order outputted from the order development circuit 120. The order signal thus dropped is outputted to the order buffering sections 112 and 113. The order buffering sections 112 and 113 consist of storage means such as FIFO memories, and store and buffer high speed ringing relay control order signals until orders are issued from the order output control circuits 115 and 116, respectively.

The order output gate signal generation circuit 114 inputs a zero crossing synchronization signal outputted from the zero crossing point detection circuit 130, generates a ringing relay control order output signal (or a gate signal) synchronous with this synchronization signal, and outputs the ringing relay control order output signal (or the gate signal) thus generated to the order output control circuits 115 and 116.

The order output control circuits 115 and 116 read the ringing relay control orders from the order buffering sections 112 and 113 in response to the gate signal outputted from the order buffering gate signal generation circuit 114, and output the ringing relay control order thus read to the subscriber circuits #0200 and#N200, respectively.

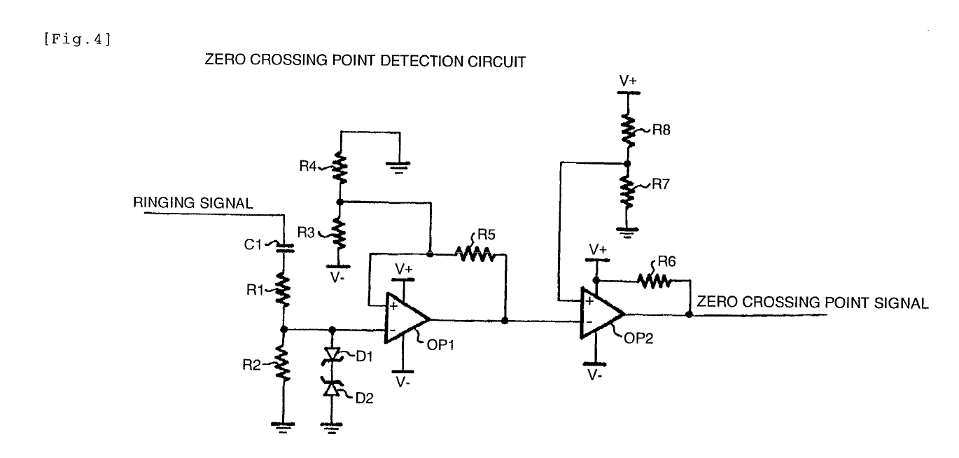

FIG. 4 is a circuit diagram showing an example of the constitution of the zero crossing point detection circuit 130 in this embodiment. The zero crossing point detection circuit 130 inputs a ringing signal, and generates a zero crossing point synchronization signal having a potential of VB (V). In FIG. 4, the zero crossing point detection circuit 130 inputs a ringing signal from the ringing signal transmission device 500. The ringing signal is inputted into the reversal input terminal of an operational amplifier OP1 by way of differential circuits C1, R1 and R2. A serial circuit consisting of voltage suppression Zener diodes D1 and D2 is connected to the reversal input terminal of the operational amplifier OP1 to suppress an input voltage equal to or higher than a certain voltage level and to prevent the input of over voltage. Further, A resistor R5, and potential division circuit resistors R3 and R4 between a negative power supply and a ground potential are connected to a feedback circuit from the output of the non-reversal terminal of the operational amplifier OP1. Also, the output of the operational amplifier OP1 is connected to the reversal input terminal of an operational amplifier OP2, and potential division circuit resistors R7 and R8 between a positive power supply and the ground potential are connected to the non-reversal input terminal of the operational amplifier OP2. The operational amplifier OP2 outputs a zero crossing point synchronization signal through a load resistor R6 connected to the positive power supply supply.

(2) Description of Operation

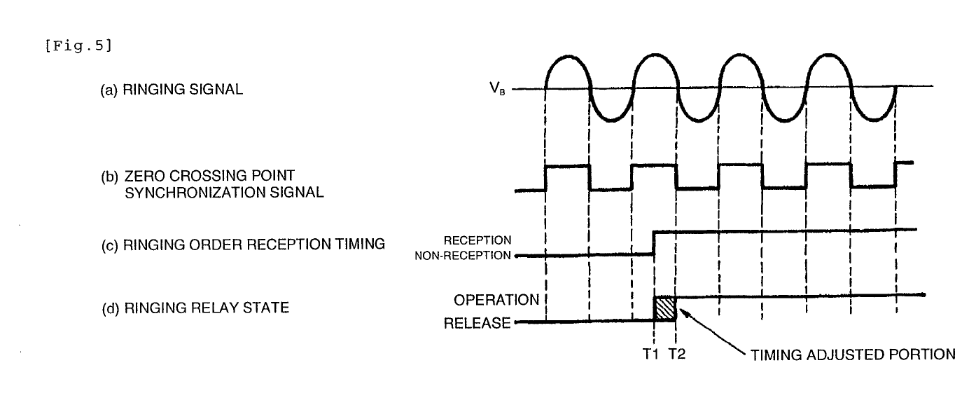

The operation of this embodiment will be described. First, an operation for generating a zero crossing point synchronization signal will be described with reference to the timing chart of FIG. 5.

In FIG. 4, the operational amplifier OP1 into which the ringing signal is inputted, outputs a low level when the ringing signal is higher in voltage than the potential division voltage of the resistors R3 and R4, and outputs a high level when lower than the potential division voltage of the resistors R3 and R4. Next, the operational amplifier OP2 outputs a low level when the input voltage of the operational amplifier OP2 is higher than the potential division voltage of the resistors R7 and R8, and outputs a high level when the input voltage is lower than the potential division voltage of the resistors R7 and R8. Therefore, if the potential division voltage of the resistors R3 and R4 is a negative voltage close to VB and that of the resistors R7 and R8 is a positive voltage close to VB, the zero crossing point detection circuit 130 outputs a zero crossing point synchronization signal shown in FIG. 5(b). Needless to say, the zero crossing signal detection circuit may be a circuit other than the circuit of FIG. 4.

The zero crossing point signal thus obtained is generated so as to change from ‘0’to ‘1’ or ‘1’ to ‘0’ at the voltage VB (V) of the ringing signal. The order output gate signal generation circuit 114 detects this change point and generates an order gate output signal.

On the other hand, the operation of the order output timing adjustment circuit 110 is executed according to a timing chart shown in FIG. 5. In FIG. 5, if a ringing signal (a) at 440 Hz close to a sinusoidal wave is inputted, the zero crossing point detection circuit 130 converts the ringing signal (a) into a pulse signal which repeatedly rises and falls every time the ringing signal (a) becomes a zero level, and outputs the pulse signal. The zero crossing point synchronization signal (b) synchronous with the ringing signal is supplied from the zero crossing point detection circuit 130 to the order output control circuits 115 and 116.

At this moment, the zero crossing point synchronization signal (b) is constantly outputted from the zero crossing point detection circuit 130. As shown in FIG. 5, if a ringing order reception timing signal (c) is received by the order buffering section 112 at the timing of T1 as shown in FIG. 5, timing for outputting a ringing order signal from the order output gate signal generation circuits 115 and 116 is generated according to the zero crossing point synchronization signal (b) at the timing of T2 shown in FIG. 5. At the timing of T2 shown in FIG. 5, the order output control circuit 115 reads a ringing control order signal from the order buffering section 112 and outputs the ringing control order signal thus read to the subscriber circuit #0 (200).

Next, the relay control circuit 210 receives this ringing control order signal when rising as shown in a ringing relay state (d), and actuates the ringing relays RL1 and RL2 at the timing of T2 shown in FIG. 5. By actuating the ringing relays at this timing, it is possible to prevent the telephone set 600 from being influenced by the generation of overvoltage on the subscriber line during the operation of the relays RL1 and RL2 and also to prevent the other subscriber circuits from being applied with inductive noise components.

Furthermore, the ringing signal from the ringing signal transmission circuit 500 on/off controls the switch relay RL1 of the subscriber circuit 200 for a predetermined time, and the ringing signal is supplied to the switch relay RL1 until hanging up the receiver of the telephone set or for a predetermined time to thereby stop the switch relay RL1.

[Second Embodiment]

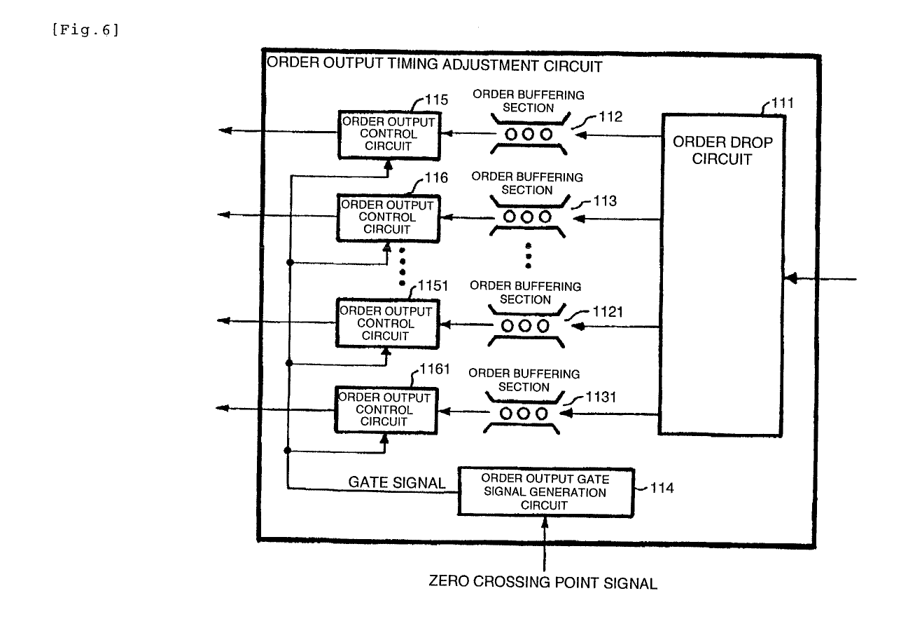

The second embodiment according to the present invention will be described hereinafter. While the second embodiment is the same in basic constitution as that described above, this embodiment is characterized in that in the order output timing adjustment circuit 110 of FIG. 3 number of order buffering sections 112, 113 and that of order output control circuits 115 and 116 are increased according to the number of subscriber circuits 200 accommodated in the exchange and the order output timing adjustment circuit 110 is formed into an integrated circuit, thereby making it possible to further reduce cost. The constitution of the second embodiment is shown in FIG. 6.

As shown in FIG. 6, the number of two order buffering sections 1121, 1131, and that of order output control circuits 1151 and 1161 are increased according to the number of subscriber circuits accommodated in the exchange and an entire order output timing adjustment circuit is formed into an integrated circuit to thereby make it possible to further reduce cost, compared with the case of two subscribers shown in FIG. 3.

Here, the order buffering section 112 may be a small capacity recording medium for ordering “turn on the ringing signal of a telephone set #005”. Thus, the order buffering section 112 may be a DRAM or a high speed SRAM. The order output control circuit 115 mainly controls output timing. Therefore, if the switch circuit of the order drop circuit 111, the order buffering sections 112 and the like and the order output control circuits 115 and the like are constituted out of an LSI circuit, it is possible to contribute to making the entire apparatus small in size and to thereby the improvement of the reliability of the apparatus. Further, a ringing signal transmission device may function as a type of a clock oscillation circuit and output a ringing signal using the oscillation circuit of a CPU mainly controlled by the exchange.

As stated so far, by providing the subscriber circuit terminating device with the structure of preventing overvoltage on subscriber lines while the ringing relays are operating in subscriber circuits, it is possible to reduce the number of circuits provided for every subscriber circuit so as to prevent overvoltage on the subscriber lines and to reduce a unit price per subscriber line. It is, therefore, possible to considerably reduce the cost of the exchange accommodating many subscriber circuits.

What is claimed is:

1. A telephone subscriber call signal control device for calling a telephone set connected to a subscriber circuit by means of a ringing signal when an incoming call is outputted from a subscriber circuit terminating device wherein:
said subscriber circuit terminating device comprises:
a zero crossing point detection circuit for generating a zero crossing point synchronization signal synchronous with a zero potential of said ringing signal, and an order output timing adjustment circuit for adjusting output timing of a ringing control order for controlling a ringing relay of said subscriber circuit synchronously with the zero crossing point synchronization signal, and
said telephone set is called by said ringing signal through said subscriber circuit synchronously with said zero crossing point synchronization signal in accordance with reception of an order to output a command to turn on said ringing relay from an order output device connected to said subscriber terminating device.

2. A telephone subscriber call signal control device according to claim 1, wherein
said subscriber circuit terminating device comprises an order buffering section specifying said subscriber circuit ringing said ringing signal in accordance with the reception of the order from said order output device, provided for said subscriber circuit and taking timing by delaying said order reception signal.

3. A subscriber circuit terminating device, including a ringing signal transmission device, for supplying a ringing signal to a subscriber circuit, comprising:
a zero crossing point detection circuit generating a zero crossing point synchronization signal synchronous with a zero potential of said ringing signal;
an order output timing adjustment circuit adjusting output timing of a ringing control order controlling a ringing relay of said subscriber circuit synchronously with said zero crossing point synchronization signal; and an order development circuit inputting an order reception signal from an order output device and analyzing said order reception signal, wherein
a telephone set is called by said ringing signal through said subscriber circuit synchronized with said zero crossing point synchronization signal by said order output timing adjustment circuit in accordance with the order reception signal from said order output device.

4. A subscriber circuit terminating device according to claim 3, wherein
said order output timing adjustment circuit comprises:
an order drop circuit specifying said subscriber circuit in response to said order reception signal analyzed by said order development circuit, and outputting said order reception signal to the subscriber circuit;
an order buffering section temporarily storing said order reception signal; and
an order output control circuit controlling timing of said order reception signal synchronously with said zero crossing point synchronization signal.

5. A subscriber circuit terminating device according to claim 4, wherein
a plurality of said subscriber circuits are provided; and
a plurality of said order buffering sections and a plurality of said order output control circuits are provided, each of the number of said order buffering sections and the number of said order output control circuits is greater than the number of said subscriber circuits.

6. A subscriber circuit terminating device according to claim 4, wherein
said order drop circuit, said order buffering section and said order output control circuit are constituted out of one LSI circuit.
